(19) United States
(12) Patent Application Publication
(10) Pub. No.: US 2026/0035561 A1
(43) Pub. Date: Feb. 5, 2026

(54) POLYAMIDE COMPOSITION AND ARTICLES PREPARED THEREFROM

(71) Applicant: Evonik Operations GmbH, Essen (DE)

(72) Inventors: Chenyu Ye, Shanghai (CN); Reinhard Linemann, Saarbruecken (DE); Varun Danke, Duesseldorf (DE); Florian Hermes, Haltern am See (DE)

(73) Assignee: Evonik Operations GmbH, Essen (DE)

(21) Appl. No.: 19/150,055

(22) PCT Filed: Nov. 6, 2023
(86) PCT No.: PCT/CN2023/129872

§ 371 Date: Jul. 22, 2025

(30) Foreign Application Priority Data
Jan. 27, 2023 (WO) PCT/CN2023/073488

(51) Int. Cl. C08L 77/06

(52) U.S. Cl. CPC C08L 77/06; C08L 2201/10; C08L 2205/03

(57) ABSTRACT

The present disclosure relates to a polyamide composition including, based on a total weight of the polyamide composition: a) a polyamide having a weight percentage of 80 wt. % to 95 wt. %; b) an acid modified polymer having a weight percentage of 0.5 wt. % to 3.8 wt. %; and c) an amine modified polymer having a weight percentage of 4.5 wt. % to 17 wt. %, wherein the polyamide composition has a transmittance of at least 85% measured according to CIE 15:2004. Also disclosed is a method to prepare the composition and an article prepared from the polyamide composition.

### FIELD OF THE PRESENT DISCLOSURE

The present disclosure relates to a polyamide composition and to articles prepared from the same.

### BACKGROUND

Transparent polymers were widely used as a replacement for glass. Polyamides, with their chemical and thermal stability, good processability, and mechanical strength, are among candidates for vari-ous applications, such as, optical applications including lenses, windows, coverings, etc.

The market desires polyamide compositions with good handling, high transparency, and high me-chanical strength. In the past, the transmittance and mechanical strength could be tuned by addition of auxiliaries or additives, such as, inorganic fillers, impact modifiers and/or compatibilizers. However, it was observed that the additives may enhance one set of performances while sacrificing another set. Thus, polyamide compositions with a delicate balance of performances, especially the balance of high transmittance, less yellow color, and high impact strength, are demanded.

Published European application EP2778190 disclosed a polyamide molding material in which an impact modifier in the form of maleic acid anhydride modified styrene-ethylene/butylene-styrene block copolymer, was introduced to the polyamide composition. The use of MAH modification leads to a higher yellow index, which is not desired in end applications such as light-transmitting compo-nents.

### SUMMARY OF THE PRESENT DISCLOSURE

It is one objective of the present disclosure to provide a polyamide composition which simultaneously can achieve desired performances including high mechanical strength, a high transmittance, and good color (i.e. less yellowing).

Such objective is achieved by providing a polyamide composition comprising, based on a total weight of the polyamide composition, a polyamide having a weight percentage of 80 wt. % to 95 wt. %; an acid modified polymer having a weight percentage of 0.5 wt. % to 3.8 wt. %; and an amine modified polymer having a weight percentage of 3 wt. % to 17 wt. %, wherein the polyamide compo-sition has a transmittance of at least 80% measured according to CIE 15: 2004 at 23° C.

Preferably, the amine modified polymer has at least comonomer selected from ethylene, propylene, 1-butylene, 2-butylene, butadiene, and styrene.

Preferably, the acid modified polymer has at least one first comonomer selected from ethylene, propylene, 1-butylene, 2-butylene, butadiene, and styrene and at least one second comonomer se-lected from maleic anhydride, itaconic anhydride, or citraconic anhydride.

Preferably, the amine modified polymer has a weight percentage of 4 wt. % to 15 wt. %, preferably 10 wt. % to 15 wt. %, based on the total weight of the polyamide composition.

Preferably, the acid modified polymer has a weight percentage of 1 wt. % to 3.5 wt. %, based on the total weight of the polyamide composition.

In a preferred embodiment of the invention the sum amount of weight percentage of amine modi-fied polymer and of acid modified polymer is 6 wt. % to 18 wt. %, based on the total weight of the polyamide composition.

Preferably, the polyamide composition has a transmittance of at least 85%, preferably at least 88%, and more preferably at least 90%, measured according to CIE 15: 2004.

Preferably, a refractive index of the amine modified polymer is within a range of 1.51 to 1.52 meas-ured according to DIN EN ISO 489: 1999 by Method A.

Preferably, a refractive index of the acid modified polymer is within a range of 1.51 to 1.52 meas-ured according to DIN EN ISO 489: 1999 by Method A. More preferably, the refractive index of both amine modified polymer and acid modified polymer is within a range of 1.51 to 1.52.

Preferably, the polyamide is selected from the group consisting of: (a1) a linear aliphatic polyamide having on average 8-14 carbon atoms in the monomer units; or (a2) a cycloaliphatic polyamide based on a cycloaliphatic diamine having 10-20 carbon atoms and an aliphatic dicarboxylic acid having 8-18 carbon atoms and optionally an aromatic di-carboxylic acid having 8-18 carbon atoms; or (a3) a semi-aromatic polyamide based on an aliphatic diamine having 2-20 carbon atoms and an aromatic dicarboxylic acid having 8-18 carbon atoms; or any mixture thereof as well as copolymer thereof.

Preferably, the polyamide is selected from the group consisting of (b1) polyamide (PA MACM12) made of bis (3-methyl-4-aminocyclohexyl) methane and dodecanedioic acid; or (b2) polyamide (PA PACM12) made of bis (4-aminocyclohexyl) methane and dodecanedioic acid; or (b3) polyamide (PA MACM10) made of bis (3-methyl-4-aminocyclohexyl) methane and decanedioic acid; or (b4) polyam-ide (PA PACM10) made of bis (4-aminocyclohexyl) methane and decanedioic acid; or (b5) polyam-ide (PA MACM14) made of bis (3-methyl-4-aminocyclohexyl) methane and tetradecanedioic acid; or (b6) polyamide (PA PACM14) made of bis (4-aminocyclohexyl) methane and tetradecanedioic acid; or any mixture or copolymer thereof.

Preferably, a test piece produced from the polyamide composition has a color b*value, measured on 2 mm thick plates according to CIE 15: 2004, of at most 3.

Preferably, a test piece produced from the polyamide composition has a color b*value, measured on 2 mm thick plates according to CIE 15: 2004, of at most 2.

Preferably, a test piece produced from the polyamide composition has an impact strength no less than 60KJ/m2, preferably 70 KJ/m2 measured according to ISO 179.

Another aspect of the invention is a method for producing the above-described inventive polyamide composition. The method comprises the step of admixing a polyamide, an acid modified polymer and an amine modified polymer to obtain the polyamide composition. Acid modified polymer and amine modified polymer can be added to the polyamide subsequently or simultaneously. In addition, the modified polymers can be admixed in dry blend.

Another perspective of the present disclosure is to provide an article prepared from the polyamide composition.

### DETAILED DESCRIPTION

The polyamide composition according to the present disclosure comprises a polyamide, an acid modified polymer, and an amine modified polymer. The polyamide composition could achieve a high transmittance, a good impact strength, while maintaining good color without visible yellowing.

The polyamide composition has such suppressed yellowing and high impact strength. A test piece produced from the same has a color b*value, measured on 2 mm thick plates according CIE 15: 2004, of at most 3, preferably of at most 2. The test piece has an impact strength no less than 60 kJ/m², 70 kJ/m² measured according to ISO 179.

The polyamide composition may be processed into articles by melting and moulding by processes known to those skilled in the art such as selective laser sintering, composite filament fabrication, selective heat sintering, fusion deposition modelling, fused filament fabrication, injection moulding, extrusion, pressing, or rolling.

The articles may be in used in one of the following sectors: electrical equipment, sports items, opti-cal equipment, sanitary and hygiene items, household equipment, communications technology, au-tomobile technology, energy and drive technology, mechanical engineering, protective eyewear, protective shields, housings, or medical equipment.

### Polyamide

The polyamide used in the present disclosure may include at least one selected from the group consisting of:
(a1) a linear aliphatic polyamide having on average 8-14 carbon atoms in the monomer units,
(a2) a cycloaliphatic polyamide based on a cycloaliphatic diamine having 10-20 carbon atoms and an aliphatic dicarboxylic acid having 8-18 carbon atoms and optionally an aromatic di-carboxylic acid having 8-18 carbon atoms,
(a3) a semi-aromatic polyamide based on an aliphatic diamine having 2-20 carbon atoms and an aromatic dicarboxylic acid having 8-18 carbon atoms,
and the mixture thereof as well as the copolymer thereof.

The polyamide composition according to the present disclosure has a transmittance of at least 85%, preferably, at least 90%, more preferably 95%, measured according to CIE 15: 2004.

### Linear Aliphatic Polyamide

The linear aliphatic polyamide has on average from 8 to 12 carbon atoms in the individual mono-mer units. Said polyamide is producible from a combination of diamine and dicarboxylic acid, from an ω-aminocarboxylic acid and/or the corresponding lactam. The monomer units in question are therefore the units which derive from lactam, ω-aminocarboxylic acid, diamine or dicarboxylic acid. The following polyamides are suitable by way of example:
Average of 8 carbon atoms: PA88, PA79, PA97, PA610, PA106
Average of 8.5 carbon atoms: PA 89, PA98, PA611, PA116, PA512
Average of 9 carbon atoms: PA99, PA810, PA108, PA612, PA126
Average of 9.5 carbon atoms: PA910, PA109, PA811, PA118, PA613, PA136, PA514
Average of 10 carbon atoms: PA10, PA1010, PA812, PA128, PA614, PA146
Average of 10.5 carbon atoms: PA1011, PA813, PA138, PA516
Average of 11 carbon atoms: PA11, PA1012, PA1210, PA913, PA139, PA814, PA148, PA616
Average of 11.5 carbon atoms: PA1112, PA1211, PA1013, PA1310, PA914, PA149, PA815, PA617, PA518
Average of 12 carbon atoms: PA12, PA1212, PA1113, PA1014, PA1410, PA816, PA618

Suitable polyamides further include copolyamides which, on the basis of suitable comonomer se-lection, comply with the proviso that the monomer units comprise on average 8 to 12 carbon atoms, for example the copolyamide composed of laurolactam, decanediamine and dodecanedioic acid (co-PA12/1012). It will be appreciated that the component employed may also be mixtures of ap-propriate polyamides, sufficient mutual compatibility being advantageous.

Preferably employed linear aliphatic polyamides are PA612, PA1010, PA1012, PA11 or PA12, par-ticularly preferably PA11 or PA12.

### Cycloaliphatic Polyamide

The cycloaliphatic polyamide is based on a cycloaliphatic diamine having 10-20 carbon atoms and an aliphatic dicarboxylic acid having 8-18 carbon atoms and optionally an aromatic di-carboxylic acid having 8-18 carbon atoms.

Preferably, the polyamide is selected from the group consisting of:
polyamide (PA MACM12) made of bis (3-methyl-4-aminocyclohexyl) methane and dodecane-dioic acid,
polyamide (PA PACM12) made of bis (4-aminocyclohexyl) methane and dodecanedioic acid,
polyamide (PA MACM10) made of bis (3-methyl-4-aminocyclohexyl) methane and decanedioic acid,
polyamide (PA PACM10) made of bis (4-aminocyclohexyl) methane and decanedioic acid,
polyamide (PA MACM14) made of bis (3-methyl-4-aminocyclohexyl) methane and tetradecanedioic acid,
polyamide (PA PACM14) made of bis (4-aminocyclohexyl) methane and tetradecanedioic ac-id, and any mixture or copolymer thereof.

The nomenclature used here for the polyamides is in accordance with EN ISO 1874-1. Accordingly, PA PACMX describes a polyamide composed of monomer units which derive from bis (4-aminocy-clohexyl) methane (PACM) and a linear dicarboxylic acid having X carbon atoms. According to the invention said linear dicarboxylic acid having X carbon atoms may be:
X=8: octanedioic acid (suberic acid);
X=9: nonanedioic acid (azelaic acid);
X=10: decanedioic acid (sebacic acid);
X=11: undecanedioic acid;
X=12: dodecanedioic acid;
X=13: tridecanedioic acid (brassylic acid);
X=14: tetradecanedioic acid;
X=15: pentadecanedioic acid;
X=16: hexadecanedioic acid;
X=17: heptadecanedioic acid; and
X=18: octadecanedioic acid.

The PA PACMX is typically produced from PACM and the dicarboxylic acid by polycondensation in the melt according to known processes. However, derivatives thereof may also be employed, for example the diisocyanate which derives from PACM, or a dicarboxylic diester.

PACM exists as a mixture of cis, cis, cis, trans and trans, trans isomers. It is commercially available with various isomer ratios. In one preferred embodiment the trans, trans isomer content of the PACM or of the employed derivative thereof is 10 to 70 wt. %, more preferably 30 to 70 wt. % and particularly preferably from 35 to 65 wt. %, based on the total content of PACM.

It is particularly preferable when the PA PACMX is a PA PACM12 in which the trans, trans isomer content of the PACM or of the employed derivative thereof is 30 to 70 wt-% and especially prefera-bly 35 to 65 wt-%, based on the total content of PACM.

### Semi-Aromatic Polyamide

Semi-aromatic polyamides are often known as polyphthalamides (PPAs). The semi-aromatic poly-amide according to the present disclosure preferably contains an aliphatic diamine and an aromatic dicarboxylic acid. The aromatic dicarboxylic acid preferably has 8 to 22 carbon atoms. Semi-aro-matic polyamides are prepared from a combination of diamine and dicarboxylic acid, optionally with addition of an ω-aminocarboxylic acid or of the corresponding lactam. Examples of suitable types include PA66/6T, PA6/6T, PA6T/MPMDT (MPMD stands for 2-methylpentamethylenediamine), PA9T, PA1OT, PA1IT, PA12T, PA14T, and also co-polycondensates of these latter types with an aliphatic diamine and an aliphatic dicarboxylic acid or with an (-aminocarboxylic acid and/or a lac-tam.

Acid modified polymers and amine modified polymers are two families of polymers resulted from modification of a base polymer with acid/anhydride or amine functionalizing agents, respectively.

### Acid Modified Polymer

Acid modified polymers refer to a family of copolymers that are resultants of acid functionalization of a base polymer. The acid modified polymers may be prepared from a base polymer and an un-saturated acid or anhydride as a functionalizing agent through an acid modification process. This acid modification may be carried out by grafting a base polymer with unsaturated carboxylic acids and/or unsaturated carboxylic acid derivatives. Preferably, a carboxylic acid or a carboxylic acid de-rivative selected from the group consisting of unsaturated carboxylic esters and unsaturated car-boxylic anhydrides is used. The conditions under which the grafting of the base polymer proceeds are well known to a skilled person. Acid modified polymer contains carboxylic groups or anhydride groups in the macromolecule introduced by the modification process.

The unsaturated carboxylic acid is a carboxylic acid with at least one unsaturated carbon-carbon bond. Preferably, the unsaturated carboxylic acid is one or more selected from acrylic acid, meth-acrylic acid, alpha ethylacrylic acid, maleic acid, fumaric acid, itaconic acid, citraconic acid, aconitic acid, tetrahydrophthalic acid, or butenylsuccinic acid.

The unsaturated carboxylic ester is an ester of an unsaturated carboxylic acid. Preferably, the un-saturated carboxylic ester is one or more selected from esters of acrylic acid, methacrylic acid, al-pha ethylacrylic acid, maleic acid, fumaric acid, itaconic acid, citraconic acid, aconitic acid, tetrahy-drophthalic acid, or butenylsuccinic acid.

The unsaturated carboxylic anhydride is an anhydride of an unsaturated dicarboxylic acid. Prefera-bly, the unsaturated carboxylic anhydride is one or more selected from maleic anhydride, itaconic anhydride, or citraconic anhydride.

The base polymers may include a homopolymer or copolymer. The homopolymer or copolymer may be an addition polymer or a condensation polymer. With regards to the addition polymer, it may have at least one monomer or comonomer selected from ethylene, propylene, butylene, sty-rene, butadiene, any other olefin, (meth) acrylic acid, an alkyl (meth) acrylate, (meth) acrylamide, or (meth) acrylonitrile. With regards to the condensation polymer, it may include one or more selected from polyethers, polyesters, polycarbonates, polyurethanes, polyureas, polyamides, phenol-alde-hyde resins, epoxy resins, polysiloxanes, etc. The base polymers may include, for instance, poly-ethylene (PE), polypropylene (PP), or styrene-ethylene-butylene-styrene copolymer (SEBS).

Exemplary acid modified polymer has at least one first comonomer selected from ethylene, propyl-ene, 1-butylene, 2-butylene, butadiene, and styrene and at least one second comonomer selected from maleic anhydride, itaconic anhydride, or citraconic anhydride.

As an example, acid modified polymers include polyethylene-graft-maleic anhydride, maleic anhy-dride-grafted PE, maleic anhydride-grafted PP, styrene-maleic anhydride copolymer, maleic anhy-dride-methyl methacrylate copolymer, maleic anhydride grafted SEBS, or maleic anhydride-acryla-mide copolymer.

According to the present disclosure, the degree of functionalization is 0.5 wt. % to 2.5 wt. %, prefera-bly 1.0 wt. % to 2.0 wt. %, more preferably 1.2 wt. % to 1.8 wt. %, based on the total content of acid modified polymer.

The acid modified polymer may have a refractive index similar to that of the polyamide. Preferably, the refractive index of the acid modified polymer is within a range of 1.51 to 1.52.

It is observed in the present disclosure that acid modified polymer, when added into polyamide composition, could enhance the mechanical strength and optical performance, especially impact strength and transmittance, respectively. Without bound by any theory, acid modified polymer con-tains terminal carboxylic groups, which may react with unreacted amino groups in the polyamide during processing. Thus, acid modified polymer might achieve a high compatibility with polyamide. However, some acid modified polymers, such as maleic anhydride modified styrene-ethylene-butyl-ene-styrene block copolymer (MAH-SEBS), may cause visible yellowing of the resultant polyamide composition.

### Amine Modified Copolymer

It was unexpectedly found in the present disclosure that amine modified polymers, when being used as modifiers, could introduce suppressed yellowing and good transmittance to the polyamide composition.

The amine modified polymers are a family of copolymers that have amino end groups. The amine modified copolymers may be prepared from a base polymer according to methods known to a skilled person. Exemplary methods include, nitration followed by reduction, condensation followed by hydrogenation, direct amination, etc.

The base polymers may include a homopolymer or copolymer. The homopolymer or copolymer may be an addition polymer or a condensation polymer. With regards to the addition polymer, it may have at least one monomer or comonomer selected from ethylene, propylene, butylene, sty-rene, butadiene, any other olefin, (meth) acrylic acid, an alkyl (meth) acrylate, (meth) acrylamide, or (meth) acrylonitrile. With regards to the condensation polymer, it may include one or more selected from polyethers, polyesters, polycarbonates, polyurethanes, polyureas, polyamides, phenol-alde-hyde resins, epoxy resins, polysiloxanes, etc.

As an example, the amine modified polymer includes amine-modified polystyrene-poly (ethylene/bu-tylene) block-polystyrene (amine-modified SEBS).

The amine modified polymer may have a reflex index similar to that of the polyamide. Preferably, the amine modified polymer has a reflex index within a range of 1.51 to 1.52.

The present disclosure is illustrated by way of example and comparative example hereinbelow.

### Materials and Testing

The following materials were employed in the examples:
PA PACM12 from Evonik Specialty Chemicals (Shanghai) Co., Ltd. is a microcrystalline polyamide produced from bis (4-aminocyclohexyl) methane having a content of trans, trans-stereoisomer of 48% and also dodecanedioic acid; ηᵣₑₗ=1.8; enthalpy of fusion 19 J/g, which can be prepared ac-cording to the disclosure of U.S. Pat. No. 5,360,891 A.
PA MACM12 from Ems-Chemie AG is an amorphous polyamide produced from bis (3-methyl-4-aminocyclohexyl) methane and dodecanedioic acid; ηᵣₑₗ=1.7; glass transition temperature 155° C.
Tafmer™ MM6850 from Mitsui Kagaku K. K. is a maleic anhydride modified polyethylene with a ma-leic acid content of 2.5 wt. %.
Kraton® FG1901 from Kraton Performance LLC, USA is a styrene-ethylene/butylene-styrene block copolymer with 30% by wt. styrene, grafted with 1.7 wt. % maleic acid anhydride, MVR 130 ccm/10 min at 275° C. and 5 kg)
Tuftec™ M1913 from Asahi Kasei Corporation is a maleic anhydride modified SEBS thermoplastic elastomer. It is used as a compatibilizer of polar resins or an impact modifier of engineering plastics such as polyamide and polyester.
Tuftec™ MP10 from Asahi Kasei Corporation is an amine modified styrene ethylene butadiene sty-rene (SEBS) thermoplastic elastomer with a polystyrene content of 30%.

The content of residue carboxylic groups and residue amino groups within the polymer composition was conducted by titration.

For the carboxylic groups within polyamides, the polymer composition was dissolved in benzyl al-cohol under heating and then was titrated at 185° C. with an ethylene glycol solution of potassium hydroxide (KOH) against phenolphthalein as indicator.

For the amino groups within polyamides, the polymer composition was dissolved in distilled m-cre-sol at 100° C. and potentiometrically titrated with an ethanolic solution of perchloric acid (HClO₄).

For the amino groups within Tuftec™ MP10, the polymer composition was dissolved in tetrahydro-furan (THF) and potentiometrically titrated with an aqueous solution of hydrogen chloride (HCl).

Notched impact strength was determined by CEAST Resil Impactor 6967.000, according to ISO 179/1eA (Charpy) on tensile specimens ISO 527 type 1A which were cut off two ends, 80 mm×10 mm×4 mm at a temperature (23±2) ° C., relative humidity (50±10) %.

Yellow coloring of polymeric compositions is determined by measuring the CIE L*, a*, b*color (D65/10).

The CIE L*, a*, b*color (D65/2) and transmittance (Y) were determined using a spectralphotometer Konica Minolta CM-3600d. “L*” represents lightness (100-0), “a*” redness (+) or greenness (−), and “b*” yellowness (+) or blueness (−) of the sample on the CIE L*, a*, b*scale. This scale is based on the principles described in ASTM E 308 Standard Practice for Computing the Colors of Objects by Using the CIE System. The sample had a thickness of 2 mm. The measurement was based on CIE 15: 2004.

### EXAMPLES

All polyamide compositions were mixed using a Coperion ZSK-26 cm co-rotating twin screw ex-truder, discharged, pelletized to obtain the polymer composites according to the recipe indicated in Tables 1 and 2. The polyamides were fed into the main port of extruder and then mixed at 280° C., and the modifiers were fed simultaneously into the extruder.

The polymer compositions in pellet form were processed on an injection moulding machine Engel VC 650/200 (melt temperature 280° C.; mould temperature 60° C.) to prepare specimens for mechan-ical performance tests and optical tests.

The mechanical and optical results of samples made from polyamide compositions in examples (E1 through E6), comparative examples (C1 through C4), and raw materials (R1 and R2) are shown in Tables 1 and 2. The COOH and amine contents in composition according to comparative example C4 was not presented due to its poor solubility in the above-mentioned solvent. It is note-worthy that no test piece was successfully prepared from the polyamide composition in the compar-ative example C4. The reason was due to inadequate mechanical strength. It might be caused partly by poor compatibility when the content of modifier MP10 was as high as 20 wt. %. Therefore, compositions containing impact modifiers with content higher than 20 wt. % were not experimented or tested.

TABLE 1
Test results of specimens prepared from
raw materials and comparative examples

| | | | | | |
|---|---|---|---|---|---|
| R1 | R2 | C1 | C2 | C3 | C4 |

Composition (wt. %)

| | | | | | | |
|---|---|---|---|---|---|---|
| PA PACM 12 | 100 | 0 | 87 | 87 | 0 | 78 |
| PA MACM 12 | 0 | 100 | 0 | 0 | 87 | 0 |
| FG1901 | 0 | 0 | 0 | 13 | 13 | 0 |
| MM6850 | 0 | 0 | 13 | 0 | 0 | 0 |
| M1913 | 0 | 0 | 0 | 0 | 0 | 2 |
| MP10 | 0 | 0 | 0 | 0 | 0 | 20 |

Performances

| | | | | | | |
|---|---|---|---|---|---|---|
| Color b* | 0.5 | 0.9 | 6.7 | 3.5 | 2.8 | — |
| Transmittance Y* (%) | 91 | 91 | 82 | 85 | 78 | — |
| Notched impact (kJ/m²) | 14 | 13 | 68 | 72 | 69 | — |
| COOH content (mmol/kg) | 122 | 102 | — | 123 | 107 | — |
| NH₂ content (mmol/kg) | 30 | 34 | — | 10 | 21 | — |

TABLE 2
Test results of specimens prepared from examples

| | E1 | E2 | E3 | E4 | E5 | E6 |
|---|---|---|---|---|---|---|
| PA PACM 12 | 83 | 83 | 93 | 88 | 85.5 | 0 |
| PA MACM 12 | 0 | 0 | 0 | 0 | 0 | 83 |
| FG1901 | 2 | 0 | 0 | 0 | 0 | 0 |
| M1913 | 0 | 2 | 2 | 2 | 2 | 2 |
| MP10 | 15 | 15 | 5 | 10 | 12.5 | 15 |
| Color b* | 1.3 | 1.5 | 1 | 1.1 | 1.1 | 1.4 |
| Transmittance Y* (%) | 90 | 90 | 88 | 87 | 87 | 86 |
| Notched impact (kJ/m²) | 75 | 77 | 80 | 82 | 80 | 72 |
| COOH content (mmol/kg) | 98 | 98 | 119 | 109 | 102 | 84 |
| NH₂ content (mmol/kg) | 27 | 27 | 25 | 26 | 26 | 33 |

It could be observed that acid functionalized impact modifiers with reflex index 1.51-1.52 can offer higher impact strength to transparent nylon and keep good transmittance. However, the color of re-sulted mixtures is usually yellow (comparative examples C1 and C2).

Amine functionalized impact modifiers with reflex index 1.51-1.52 can offer less yellowing and good transmittance.

When small amount of acid modification is introduced into amine impact modifier system as com-patibilizers, impact strength can be improved, while good color as well as high transmittance can be achieved (examples E1 to E6).

Various aspects and embodiments are possible. Some of those aspects and embodiments are de-scribed herein. After reading this specification, skilled artisans will appreciate that those aspects and embodiments are only illustrative and do not limit the scope of the present disclosure.

1. A polyamide composition comprising:
80 wt. % to 95 wt. % of a polyamide;
0.5 wt. % to 3.8 wt. % of an acid modified polymer; and
3 wt. % to 17 wt. % of an amine modified polymer;
wherein the wt. % is based on a total weight of the polyamide composition; and
wherein the polyamide composition has a transmittance of at least 85% measured according to CIE 15:2004 at 23° C.

2. The polyamide composition according to claim 1, wherein the amine modified polymer comprises at least one comonomer selected from the group consisting of ethylene, propylene, 1-butylene, 2-butylene, butadiene, and styrene.

3. The polyamide composition according to claim 1, wherein the acid modified polymer comprises at least one first comonomer selected from the group consisting of ethylene, propylene, 1-butylene, 2-butylene, butadiene, and styrene and at least one second comonomer selected from the group consisting of maleic anhydride, itaconic anhydride, and citraconic anhydride.

4. The polyamide composition according to claim 1, wherein the amine modified polymer has a weight percentage of 4 wt. % to 15 wt. %, based on the total weight of the polyamide composition.

5. The polyamide composition according to claim 1, wherein the acid modified polymer has a weight percentage of 1 wt. % to 3.5 wt. %, based on the total weight of the polyamide composition.

6. The polyamide composition according to claim 1, wherein a sum amount of weight percentage of the amine modified polymer and of the acid modified polymer is 6 wt. % to 18 wt. %, based on the total weight of the polyamide composition.

7. The polyamide composition according to claim 1, wherein the polyamide composition has a transmittance of at least 88% measured according to CIE 15:2004.

8. The polyamide composition according to claim 1, wherein a refractive index of the amine modified polymer or of the acid modified polymer is within a range of 1.51 to 1.52 measured according to DIN EN ISO 489:1999 by Method A.

9. The polyamide composition according to claim 1, wherein the polyamide is selected from the group consisting of:
(a1) a linear aliphatic polyamide having on average 8-14 carbon atoms in a monomer unit;
(a2) a cycloaliphatic polyamide based on a cycloaliphatic diamine having 10-20 carbon atoms and an aliphatic dicarboxylic acid having 8-18 carbon atoms and optionally an aromatic dicarboxylic acid having 8-18 carbon atoms; and
(a3) a semi-aromatic polyamide based on an aliphatic diamine having 2-20 carbon atoms and an aromatic dicarboxylic acid having 8-18 carbon atoms; or
a mixture thereof as well as a copolymer thereof.

10. The polyamide composition according to claim 1, wherein the polyamide is selected from the group consisting of
(b1) a polyamide (PA MACM12) made of bis(3-methyl-4-aminocyclohexyl)methane and dodecanedioic acid;
(b2) a polyamide (PA PACM12) made of bis(4-aminocyclohexyl)methane and dodecanedioic acid;
(b3) a polyamide (PA MACM10) made of bis(3-methyl-4-aminocyclohexyl)methane and decanedioic acid;
(b4) a polyamide (PA PACM10) made of bis(4-aminocyclohexyl)methane and decanedioic acid;
(b5) a polyamide (PA MACM14) made of bis(3-methyl-4-aminocyclohexyl)methane and tetradecanedioic acid; and
(b6) a polyamide (PA PACM14) made of bis(4-aminocyclohexyl)methane and tetradecanedioic acid;
and a mixture or a copolymer thereof.

11. The polyamide composition according to claim 1, wherein a test piece produced from the polyamide composition has a color b* value, measured on 2 mm thick plates according to CIE 15:2004, of at most 3.

12. The polyamide composition according to claim 1, wherein a test piece produced from the polyamide composition has a color b* value, measured on 2 mm thick plates according to CIE 15:2004, of at most 2.

13. The polyamide composition according to claim 1, wherein a test piece produced from the polyamide composition has a notched impact strength of no less than 60 kJ/m², measured according to ISO 179.

14. A method for producing the polyamide composition according to claim 1 by admixing the polyamide, the acid modified polymer, and the amine modified polymer.

15. An article prepared from the polyamide composition according to claim 1.
